(19) United States
(12) Patent Application Publication
(10) Pub. No.: US 2026/0120204 A1
(43) Pub. Date: Apr. 30, 2026

(54) SYSTEM AND METHOD FOR COMPREHENSIVE WATER, CARBON, AND ENERGY FOOTPRINT MONITORING

(71) Applicant: Gary Katz, HOUSTON, TX (US)

(72) Inventor: Gary Katz, HOUSTON, TX (US)

(73) Assignee: Katz Water Tech, LLC, Houston, TX (US)

(21) Appl. No.: 18/824,899

(22) Filed: Sep. 4, 2024

Related U.S. Application Data
(60) Provisional application No. 63/536,494, filed on Sep. 4, 2023.

(51) Int. Cl. G06Q 50/06; G01F 15/063; G01M 3/24; G06Q 30/018

(52) U.S. Cl. CPC G06Q 50/06; G01F 15/063; G01M 3/24; G06Q 30/018

(57) ABSTRACT

A water management technology is disclosed, including devices, systems, and methods for monitoring, managing, and reducing water usage alone or in combination with carbon footprint. In one embodiment, the device comprises a real-time water metering system, leak detection sensors, integration means for various water recycling and purification technologies, a processor for analyzing water usage data, and a communication interface. The system involves a comprehensive approach that combines monitoring and reducing both water and carbon footprints, including footprint monitoring services, reduction processes, and an integrated dashboard. The method encapsulates measuring consumption, detecting leaks, integrating data points, and analyzing water and energy consumption through the use of IoT devices, advanced algorithms, and collaboration with energy providers. The invention can leverage a range of existing technologies and provides actionable insights for conservation, efficiency, and sustainability, facilitating water stewardship, and compliance with environmental regulations.

### CROSS-REFERENCE TO RELATED APPLICATIONS

The present application is a new United States Non-Provisional Patent Application that claims priority to U.S. Provisional Patent Application No. 63/536,494 titled “SYSTEM AND METHOD FOR COMPREHENSIVE WATER FOOTPRINT MONITORING” filed on Sep. 4, 2024. U.S. Provisional Patent Application No. 63/536,494 is hereby incorporated by reference in its entirety.

### FIELD

The invention relates to monitoring the operational performance of fluid monitoring systems. More particularly, the embodiments relate to the monitoring and management of water usage and, more particularly, to a system and method for comprehensive water footprint monitoring.

### BACKGROUND OF THE INVENTION

Water is an essential resource. It is important to monitor the amount and the quality of water that is available. Tracking water usage and utilization may become as crucial as tracking CO2 emissions. Various technologies are currently in place to help companies monitor their water usage or footprint. Smart meters, for example, provide real-time information on consumption, allowing consumers and businesses to identify wasteful practices and reduce usage. Flow sensors are commonly used in industrial settings to detect the rate of water flow in pipes and channels, helping to identify leaks and inefficiencies.

Remote sensing technology, utilizing satellite and drone imagery, offers a broad view of water usage, especially in agriculture and large-scale water management projects. Specialized water management software solutions integrate with these sensors and meters to provide a comprehensive view of water consumption patterns. Such integration assists companies in implementing water-saving strategies, while technologies like chemical analysis and thermal distillation are employed to assess the quality and quantity of wastewater, guiding recycling and reclamation processes.

The need for comprehensive water footprint monitoring extends beyond simple conservation. It offers insights into the overall water footprint, including consumption, pollution, and impacts across the entire value chain. The growing urgency for an approach akin to CO2 monitoring stems from factors like global water scarcity, increasing demands for freshwater, and changing climate conditions. These challenges make water scarcity a widespread issue and comprehensive monitoring could lead to more effective management and conservation of water resources and more efficient carbon management in view of the need for more water resources to support population growth and industrialization efforts in an environmentally sustainable manner.

Additionally, governments and international bodies are imposing stricter regulations on water usage and pollution. For businesses, detailed monitoring allows for transparency and compliance with these laws. It aligns with broader sustainability goals and Environmental, Social, and Governance (ESG) strategies. The role of water in business continuity and risk management cannot be understated; water scarcity and mismanagement can disrupt operations, and comprehensive monitoring helps in identifying risks and ensuring efficient use of water resources.

Furthermore, social responsibility and brand image are becoming integral to corporate strategies. Transparent water management enhances a company's reputation and meets the growing customer demand for responsible environmental stewardship.

Water footprint monitoring requires a more integrated and comprehensive approach, similar to CO2 monitoring. Existing technologies like smart meters, flow sensors, remote sensing, and software solutions provide valuable insights, but there is room for innovation and greater collaboration. As the world grapples with water scarcity, pollution, and sustainability, the call for advanced water footprint monitoring grows clearer. The drive towards comprehensive water monitoring parallels the advances in CO2 tracking, reflecting a broader movement towards sustainability and responsible resource management. There is a need to leverage existing technologies and develop new solutions to offer a more holistic view of water usage, aligning with global goals, and ensuring effective and responsible management. Accordingly, embodiments of the invention described herein satisfy these needs.

### SUMMARY OF THE INVENTION

Embodiments of the invention relate to devices, systems, and methods for monitoring fluids. In one embodiment a water monitoring and/or management device is disclosed. The device comprises a water metering system for real-time measurement; leak detection sensors for immediate reporting of leaks; integration means for water recycling and purification technologies; a processor configured to analyze water usage data; and a communication interface.

In one embodiment a system for comprehensive combined CO2 and water monitoring is disclosed. The system comprises a water footprint monitoring system or service; CO2 monitoring subsystems; footprint reduction processes for both water and carbon; and an integrated dashboard for real-time insight.

In one embodiment a method for monitoring, managing, and reducing water usage is disclosed. The method comprises in one embodiment the four steps of measuring real-time consumption; detecting and reporting leaks; integrating various data points; and analyzing water and energy consumption.

### BRIEF DESCRIPTION OF THE DRAWINGS

The foregoing is intended to give a general idea of the invention and is not intended to fully define nor limit the invention. The invention will be more fully understood and better appreciated by reference to the following description and drawings.

FIG. 1 is a schematic embodiment of how a water footprint system works;

FIG. 2 is a flow chart embodiment of how a water footprint system works;

### DETAILED DESCRIPTION

Before describing selected embodiments of the present disclosure in detail, it is to be understood that the present invention is not limited to the embodiments described herein. The disclosure and description herein are illustrative and explanatory of one or more presently preferred embodiments and variations thereof, and it will be appreciated by those skilled in the art that various changes in the design, organization, means of operation, structures and location, methodology, and use of mechanical equivalents may be made without departing from the spirit of the invention.

The drawings are intended to illustrate and disclose presently preferred embodiments to one of skill in the art but are not intended to be manufacturing-level drawings or renditions of final products and may include simplified conceptual views to facilitate understanding or explanation. Also, the relative size and arrangement of the components may differ from that shown and still operate within the spirit of the invention.

Moreover, it will be understood that various directions such as “upper”, “lower”, “bottom”, “top”, “left”, “right”, “first”, “second”, and so forth are made only concerning explanation in conjunction with the drawings, and that components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

Embodiments of the present invention provide a system and method for comprehensive water footprint monitoring. It leverages existing technologies and integrates them into a coherent strategy to monitor, manage, and reduce water usage across different levels. The invention encompasses direct consumption, indirect consumption related to energy use, and consumption within the entire value chain. By monitoring water usage at these levels, operators or companies can gain a detailed understanding of their water footprint, empowering them to take effective actions toward conservation, efficiency, and sustainability.

Additional embodiments disclosed herein provide systems and methods for comprehensive water footprint monitoring. These systems and methods comprise several components and processes. These include advanced water metering systems, leak detection sensors, building management systems, wastewater treatment and reuse technologies, energy management systems, life cycle assessment tools, supply chain management software, product life cycle analysis software, customer engagement tools, third-party verification services, data analytics platforms, IoT devices and sensors, cloud computing, and machine learning algorithms.

U.S. patent application Ser. No. 18/236,396 entitled “REMOTE TANK MONITORING DEVICE SYSTEM AND METHOD” filed on Aug. 21, 2023, discloses IOT devices, Artificial Intelligence (AI), and Machine Learning (ML) to help improve water management. U.S. patent application Ser. No. 18/236,396 is hereby incorporated by reference in its entirety. The devices, systems, and methods can be used herein to help monitor and improve water footprint as well as CO2 footprint. Additional sensors can monitor properties related to water including but not limited to energy, air quality, soil properties, and combination thereof. These additional sensors can create an integrated systems that monitors all aspects of the environment.

At the first level of direct consumption, advanced water metering systems are used to measure real-time water consumption within facilities. Leak detection sensors are deployed to quickly detect and report leaks, minimizing waste. Building management systems integrate various data points, enabling efficient control over water usage in cooling systems, restrooms, and other areas. Additionally, technologies that allow for the treatment and reuse of wastewater are implemented to significantly reduce direct water consumption.

At the second level, which involves indirect consumption related to energy use, energy management systems analyze the water footprint associated with energy consumption. Life cycle assessment tools evaluate water usage throughout the entire energy production process, providing a comprehensive understanding of this level of water usage. Collaboration with energy providers to gain insights into water intensity is also an essential aspect of tracking second-level usage.

The third level encompasses water consumed within the entire value chain, from suppliers to end-users. Supply chain management software tracks and manages this consumption, while product life cycle analysis software evaluates the water footprint throughout a product's life. Customer engagement tools provide information about water consumption patterns during product usage, fostering awareness and encouraging responsible water use. Third-party verification services with specialized tools validate and verify water usage data across the value chain.

Several common technologies can be applied across all levels. Data analytics platforms analyze water usage data and identify trends, while IoT devices and sensors offer real-time monitoring and control. Cloud computing facilitates data storage, sharing, and collaboration, and machine learning algorithms predict water consumption patterns and recommend proactive measures for reduction.

In embodiments, the system and method for comprehensive water footprint monitoring provide a cohesive approach to monitor, manage, and reduce water usage across different levels. By leveraging a range of existing technologies, businesses can gain a detailed understanding of their water footprint, empowering them to take actionable steps toward conservation, efficiency, and sustainability. The integration of these strategies aligns with environmental goals and operational needs, mirroring the multifaceted approach needed for CO2 monitoring.

### Water Monitoring

Monitoring, managing, and reducing water usage across different levels requires the integration of various existing technologies. For direct consumption, known as the first level, technologies such as advanced water metering systems can measure real-time water consumption within facilities. Leak detection sensors are vital for quickly detecting and reporting leaks while building management systems (BMS) integrate various data points for efficient control over water usage in cooling systems, restrooms, and more. Additionally, implementing technologies that allow for the treatment and reuse of wastewater can significantly reduce direct water consumption.

The second level, or indirect consumption related to energy use, can be managed using energy management systems that analyze the water footprint related to energy consumption. Life cycle assessment tools that evaluate water usage throughout the entire energy production process enable a comprehensive understanding of this level of water usage. Collaboration platforms with energy providers can offer insights into water intensity, which is essential for tracking second-level usage.

The third level, which encompasses value chain consumption, requires supply chain management software for tracking and managing water consumption throughout the entire value chain. Product life cycle analysis software can evaluate the water footprint throughout a product's life, offering insights for potential reductions. Tools that provide information to customers about their water consumption patterns during product usage foster awareness and encourage responsible water use. Third-party verification services with specialized tools to validate and verify water usage data across the value chain are also crucial.

Common technologies across all levels can include data analytics platforms for analyzing water usage data, identifying trends, and suggesting improvements. IoT devices and sensors offer real-time monitoring and control of water usage across various stages. Cloud computing facilitates data storage, sharing, and collaboration for comprehensive water management. Machine Learning algorithms can predict water consumption patterns and recommend proactive measures for reduction.

In different embodiments, various existing technologies ranging from advanced metering systems to sophisticated analytics platforms can be leveraged to monitor, manage, and reduce water usage across different levels. Integrating these technologies into a coherent strategy allows operators or companies to gain a detailed understanding of their water footprint. This empowers them to take effective actions towards conservation, efficiency, and sustainability, aligning with both environmental goals and operational needs.

Monitoring, managing, and reducing water usage across different levels necessitate the integration of various existing technologies. Advanced water metering systems are crucial for measuring real-time water consumption within facilities at the first level of direct consumption. Leak detection sensors can quickly detect and report leaks, minimizing waste. Building management systems can integrate various data points, enabling efficient control over water usage, while technologies that allow for the treatment and reuse of wastewater can significantly reduce direct water consumption.

At the second level, or indirect consumption related to energy use, energy management systems that analyze the water footprint related to energy consumption are vital. Life cycle assessment tools can evaluate water usage throughout the entire energy production process, allowing a comprehensive understanding of second-level water usage. Collaboration with energy providers to gain insights into water intensity is also an essential aspect of tracking this level of usage.

The third level involves water consumed within the entire value chain, from suppliers to end-users. Supply chain management software can track and manage this consumption, while product life cycle analysis software helps in evaluating the water footprint throughout a product's life. Engaging customers with information about their water consumption patterns during product usage can foster awareness and encourage responsible water use. Third-party verification services with specialized tools to validate and verify water usage data across the value chain are also vital.

Several common technologies can be applied across all levels. Data analytics platforms can analyze water usage data and identify trends, and IoT devices and sensors offer real-time monitoring and control. Cloud computing facilitates data storage, sharing, and collaboration, and machine learning algorithms can predict water consumption patterns and recommend proactive measures for reduction.

leveraging a range of existing technologies from advanced metering systems to sophisticated analytics platforms can effectively monitor, manage, and reduce water usage across the first, second, and third levels. Integrating these technologies into a coherent strategy provides companies with a detailed understanding of their water footprint, empowering them to take actionable steps toward conservation, efficiency, and sustainability. It mirrors the multifaceted approach needed for CO2 monitoring, underlining the significance of water management in aligning with both environmental goals and operational needs.

### Technologies to Reduce Water Footprint

With the ever-increasing demand for freshwater resources, organizations are seeking innovative solutions to reduce water consumption and minimize waste. Water recycling and purification technologies play a vital role in achieving these goals. In one embodiment, various existing and emerging technologies that are being utilized to enhance water recycling and purification processes are utilized to reduce water footprints and or carbon footprints. Water treatment technologies that are suitable for embodiments of this invention are disclosed in U.S. Pat. No. 11,325,849. U.S. Pat. No. 11,325,849 is hereby incorporated by reference in its entirety.

Membrane Bioreactors (MBRs) are a key technology in this field, combining membrane processes like microfiltration with biological treatment. MBRs are highly effective in treating wastewater, removing solids, bacteria, and viruses, and producing high-quality effluent suitable for various reuse applications. Reverse Osmosis (RO) uses a semipermeable membrane to remove ions, molecules, and larger particles from water and is extensively used to desalinate seawater and treat wastewater for reuse. Greywater recycling systems are another innovation, targeting domestic or commercial wastewater from sinks, showers, and laundry, treating and reusing water for landscaping, flushing toilets, or industrial cooling. Constructed wetlands are also an option, mimicking natural wetland processes to treat wastewater through biological processes and turn it into reusable water.

In the realm of water purification, ultrafiltration (UF) uses hydrostatic pressure to force water through a membrane, removing suspended solids, bacteria, and viruses, making it suitable for drinking and industrial purposes. Electrocoagulation (EC) employs electrodes to dissolve impurities, making them easier to remove, and is an effective method for treating water containing heavy metals or oily substances. Ultraviolet (UV) disinfection destroys the DNA of harmful microorganisms, rendering them harmless, and is a chemical-free method used in both municipal and industrial water treatment. Activated carbon filtration uses porous carbon to absorb impurities, removing odor, taste, and organic contaminants from water. Ozone treatment, which dissolves ozone gas in water to oxidize contaminants, offers another chemical-free purification solution.

Adding to the list of water purification methods, thermal distillation is a process that involves heating water to create steam, which then cools and condenses into purified water. This method effectively separates contaminants from the water, making it a valuable technique for desalination and purification. Alternative energy technologies that are suitable for embodiments of this invention are disclosed in U.S. Patent Publication No. 20230278891-A1. U.S. Patent Publication No. 20230278891-A1 is hereby incorporated by reference in its entirety.

Many modern facilities are integrating these technologies into a cohesive water management strategy. Combining different recycling and purification technologies enables more flexible and efficient water treatment, tailored to specific needs and local regulations. Investing in water recycling and purification not only aids in compliance with environmental regulations but also promotes sustainability. It's important to note that these technologies can be energy-intensive, so considering energy efficiency, renewable energy integration, and lifecycle assessments will ensure a holistic approach to water management. U.S. Pat. No. 10,864,482 discloses energy efficient and renewable energy water management systems. U.S. Pat. No. 10,864,482 is hereby incorporated by reference in its entirety.

In one embodiment, the effective reduction of water footprints requires a comprehensive understanding and application of various water recycling and purification technologies. From established methods like RO and UV disinfection to emerging approaches like electrocoagulation and thermal distillation, a multitude of options is available to suit different needs and contexts. By investing in these technologies and integrating them thoughtfully, operators and companies can significantly reduce their water consumption, aligning with global sustainability goals and ensuring long-term resilience in a world where water resources are increasingly scarce. Continuous innovation and research in this field promise even more effective solutions in the future, underscoring the importance of ongoing commitment to water stewardship.

### Smart Meters

In one embodiment, smart meters form a component of the present invention. Smart water meters are designed to monitor real-time water usage with high accuracy. These meters operate based on advanced sensor technology, coupled with digital communication interfaces, to record and transmit water consumption data to a central system. Unlike traditional water meters that merely log cumulative water usage, smart meters offer granularity by capturing time-stamped data at regular intervals. This enables a dynamic understanding of water consumption patterns, including peak usage times and potential inefficiencies, which traditional meters are incapable of providing. U.S. patent application Ser. No. 18/811,709, filed on Aug. 19, 2024, titled “REMOTE FLUID MONITORING DEVICE SYSTEM AND METHOD” discloses smart water meters that are suitable for embodiments of this invention. U.S. patent application Ser. No. 18/811,709 is hereby incorporated by reference in its entirety.

The smart meters can be equipped with specialized sensors for various metrics, such as flow rate and pressure, thereby enabling more sophisticated analyses like leak detection or unusual usage spikes. The digital capabilities of these meters extend beyond mere data collection; they are designed to be seamlessly integrated into building management systems or broader water management platforms. This ensures that the data they collect is not just an isolated stream but a contextualized piece of a larger puzzle, contributing to an ecosystem of various data points that include but are not limited to, leak reports, energy management statistics, and wastewater treatment statuses.

The utility of smart meters goes beyond just monitoring. These smart meters can play a role in managing water usage effectively. Through their integration with data analytics platforms, the time-stamped, high-resolution data can be analyzed to identify inefficiencies, calculate water footprints, and even predict future usage patterns. In conjunction with other system components like leak detection sensors and water treatment technologies, smart meters can trigger alerts or activate remedial actions automatically. For example, in the event of a detected leak, the smart meter can either send an immediate alert to the system administrators or initiate a pre-programmed response such as shutting off a particular water valve to prevent wastage. By leveraging the capabilities of smart meters, the present invention facilitates a holistic approach to water management, allowing for real-time adjustments, long-term planning, and more responsible water utilization, thus contributing significantly to water footprint reduction.

### Energy Smart Meters

In one embodiment energy smart meters are a component of the present invention. These energy smart meters are designed to provide real-time monitoring and control over electrical energy consumption. These meters employ advanced sensors and digital interfaces that facilitate both the collection and communication of energy data. Unlike conventional energy meters that only track gross consumption, these smart meters record high-resolution, time-stamped data. This enables a robust analysis of energy usage patterns, including peak demand times and potential inefficiencies that might otherwise go unnoticed. The meter's capabilities extend to the integration with home and industrial energy management systems, allowing for dynamic pricing models, remote monitoring, and automation features such as shutting down high-consumption devices during peak times, all contributing to a reduced energy footprint.

### Carbon Monitoring Technologies

In one embodiment, the present invention also incorporates smart carbon monitoring technologies to measure and manage the carbon footprint. Utilizing a combination of real-time emission sensors, satellite-based monitoring, and advanced modeling algorithms, these technologies capture a nuanced picture of an entity's carbon output. Data can be collected from various sources, including industrial processes, transportation, and electricity consumption, and then analyzed to provide actionable insights. Integrated within a broader environmental management system, these carbon monitoring technologies can trigger automated actions or alerts. For instance, if the system detects that a certain production process is emitting more carbon than preset thresholds, it can automatically adjust the process parameters or alert the system administrators, thereby contributing to effective carbon management.

### Integrated Monitoring for Water, Energy, and Carbon Management Systems for Water, Energy, and Carbon Footprints

In embodiments to achieve optimal environmental stewardship, the present invention goes beyond isolated metrics to integrate monitoring and management systems for water, energy, and carbon footprints. Each of these systems can function independently but in one embodiment, the systems are redesigned for seamless integration through a centralized dashboard. Utilizing cloud computing and advanced data analytics, this integrated system can cross-reference data streams from smart water meters, energy smart meters, and carbon monitoring technologies. As a result, entities can obtain a more comprehensive view of their environmental impacts and develop strategies that address multiple concerns simultaneously. For example, the system can correlate high water usage with energy consumption and carbon emissions and recommend or automatically initiate actions that optimize the use of all three resources. By offering this integrated approach, the invention enables a multifaceted understanding of environmental impacts, allowing organizations to act more effectively in their sustainability efforts.

In various embodiments, existing infrastructure alone or in combination with new technologies discussed herein can be collectively utilized to increase and improve the pivotal roles and synergies of smart meters and monitoring technologies for water, energy, and carbon management. These different combinations are covered as embodiments of the present invention.

### Centralized Dashboard

In one embodiment, one or more centralized dashboards are used or deployed as the hub for all data collection and analysis. The dashboard employs cloud computing to amass large volumes of data and employs machine learning algorithms for advanced analytics. With APIs that can pull data from various sources, including IoT devices, smart meters, and third-party services, the dashboard is built for extensive scalability and modularity. These dashboards are described in more detail below.

### Water Monitoring Integration

In one embodiment, smart water meters, equipped with advanced sensors and leak detection capabilities, can transmit real-time data to the dashboard. Advanced water metering systems employing ultrasonic flow meters, pressure sensors, and even blockchain for secure and transparent record-keeping can be integrated into this ecosystem. Membrane Bioreactors (MBRs) and Reverse Osmosis (RO) systems used for water desalination, purification, or recycling can also feed into the dashboard, providing insights into both water consumption and conservation.

### Energy Monitoring Integration

In one embodiment, smart meters for energy consumption, equipped with advanced energy analytics platforms, are similarly integrated into the dashboard. These meters can collect granular, time-stamped energy usage data, enabling the dashboard to analyze peak demand times and recommend or initiate demand-response actions. Energy management systems can be connected to the dashboard, allowing for streamlined data flows and easier implementation of energy-saving measures like variable frequency drives, smart grids, and energy storage solutions.

### Carbon Monitoring Integration

In one embodiment, real-time emission sensors, satellite-based monitoring, and sophisticated modeling algorithms are used for tracking the carbon footprint. These are also integrated into the centralized dashboard. Machine learning models can forecast emissions based on past data and current activity, enabling preemptive actions to reduce the carbon footprint. Technologies such as Light Detecting and Ranging (LiDAR) and IoT-based emission trackers can add another layer of accuracy to these measurements.

### Advanced Technologies for Seamless Integration

Big Data Analytics can be utilized in embodiments of the invention. For example, big data analytics can be used to handle the massive inflow of data, big data analytics platforms like Hadoop can be employed. These can process and analyze data at a much faster rate, making it easier to handle simultaneous data streams.

Artificial Intelligence can be utilized in embodiments of the invention. For example, AI algorithms can predict usage patterns and recommend proactive measures for resource conservation. These algorithms can also automate many of the system's features, such as shutting down non-essential devices during peak energy consumption times.

Blockchain can be utilized in several embodiments of the invention. For example, blockchain technology can be incorporated to provide immutable record-keeping and transparent tracking of resource consumption. This ensures the integrity of the data being collected and shared.

Edge Computing can be utilized in embodiments of the invention. For example, edge computing can be employed to process data at the source, reducing latency to provide real-time analytics and decision-making.

Cybersecurity Measures can be utilized in embodiments of the invention. For example, given the sensitivity of the data, advanced cybersecurity measures like end-to-end encryption can be integrated to safeguard against unauthorized access.

The embodiments of the present invention can change, improve, and revolutionize the way we monitor and manage environmental resources by integrating disparate systems into a unified whole. Utilizing a plethora or at least two technologies from the group consisting of IoT devices, blockchain, machine learning, big data analytics, centralized dashboard, and combinations thereof enables a real-time, holistic view of water, energy, and carbon footprints. With the ability to function either independently or as an integrated unit, this invention offers users including regulators, plant operators, and industries, unmatched flexibility and comprehensiveness, propelling organizations towards more sustainable and responsible resource management.

### Comprehensive Combined CO2 and Water Monitoring System

In the modern era, where environmental stewardship is increasingly important, organizations are turning to holistic approaches that combine monitoring and reducing both water and carbon footprints. The integration of these systems can create a comprehensive ESG process that considers various environmental impacts in unison.

Water footprint monitoring services involve the use of technologies like smart meters, IoT sensors, and data analytics to track water usage across various operations and supply chains. These tools not only measure water consumption but also analyze usage patterns to identify opportunities for reduction. Water footprint reduction processes, in turn, might encompass strategies such as wastewater recycling using Membrane Bioreactors, water purification through Reverse Osmosis, or the utilization of rainwater harvesting systems.

On the carbon side, CO2 monitoring systems often employ real-time emissions sensors, satellite-based monitoring, and sophisticated modeling algorithms to gauge the carbon footprint. Carbon reduction processes may include energy efficiency measures, renewable energy sourcing, carbon capture, and storage, or offsetting emissions through reforestation projects.

The integration of water monitoring, CO2 monitoring, combined with reduction processes can be achieved through a centralized platform that leverages the power of cloud computing, big data analytics, and artificial intelligence. By unifying these diverse data streams, companies can gain a holistic view of their environmental impacts and tailor strategies to address both water and carbon concerns simultaneously. For instance, energy management systems can be deployed to reduce both electricity consumption (thereby lowering CO2 emissions) and water usage in cooling processes. Similarly, wastewater recycling can minimize water footprint while also decreasing energy consumption for water heating, contributing to both water and CO2 reduction goals.

Current technologies, such as integrated dashboard systems, are offering real-time insights into water and carbon footprints. These dashboards pull data from various monitoring devices, both on water and carbon fronts, allowing for quick analysis and decision-making. Automation and machine learning also play vital roles, allowing for predictive modeling and automated controls that can react to changes in both water and carbon metrics.

In terms of future technologies, we might anticipate further advancements in sensor capabilities, enabling more precise measurements of both water and CO2 across diverse environments. The use of blockchain for transparent and immutable tracking of water and carbon footprints could become more prevalent. Innovations in machine learning and artificial intelligence are likely to provide more nuanced insights and automation opportunities. Furthermore, technologies like Quantum Computing might revolutionize the modeling and simulation of environmental impacts, offering unprecedented detail and foresight. This data can be utilized to help governments and large industries better regulate water, energy and carbon usage and footprints.

One embodiment relates to an integrated system for monitoring environmental variables, including water usage, energy consumption, and carbon footprints. Central to this system is a centralized dashboard that is capable of receiving and displaying real-time data. The dashboard is engineered to function as the user interface and data aggregation point for a range of sensing and metering devices.

A plurality of smart water meters are integrated into this system, each outfitted with advanced sensors and capabilities for leak detection. These meters are designed to provide highly accurate readings of water usage, pressure levels, and other vital parameters. They are operatively coupled to the centralized dashboard, sending their data to it in real-time for display and analytics.

The system also employs energy smart meters designed to collect time-stamped energy usage data, thereby providing a granular view of energy consumption patterns. These energy meters are also operatively coupled to the centralized dashboard, further enriching the dataset that it can analyze.

Additionally, the system incorporates a range of carbon emission sensors. These sensors are responsible for continuously tracking the carbon footprint generated by various activities and are operatively coupled to the centralized dashboard.

Lastly, the centralized dashboard utilizes cutting-edge cloud computing and machine learning algorithms for sophisticated data analytics. It also employs Application Programming Interfaces (APIs) to allow for seamless data integration from multiple sources, thus offering a multi-dimensional view of resource consumption.

In one embodiment a method for integrated environmental monitoring is provided. The method involves a series of steps to achieve integrated environmental monitoring. First, data from a plurality of smart water meters are collected, which include advanced sensors and leak detection capabilities. Simultaneously, data from energy smart meters and carbon emission sensors are gathered.

In one embodiment, all these disparate streams of data are aggregated in a centralized dashboard that employs cloud computing for data storage and machine learning algorithms for analytics. The dashboard then provides a multi-dimensional view of resource consumption, making it easier for end-users or system administrators to understand and manage their environmental footprint.

In another embodiment, a system for advanced environmental resource management is provided. This system advances beyond the capabilities of the integrated monitoring system described above by employing big data analytics platforms for data processing. It also includes artificial intelligence algorithms to predict resource consumption patterns and recommend proactive measures, all operatively coupled to the centralized dashboard.

Blockchain technology can be integrated into this system to offer immutable record-keeping and transparent tracking of all monitored parameters. All these technologies can come together in the centralized dashboard, configured to provide a holistic view of water, energy, and carbon footprints.

In one embodiment a method for providing real-time environmental analytics is provided. This method can leverage edge computing technology to process data at the source for reduced latency. It ensures data security through end-to-end encryption, thereby safeguarding the data being transferred and stored. This processed and secured data is then aggregated in a centralized dashboard that utilizes machine learning algorithms for real-time analytics and actionable insights.

In one embodiment a system for holistic environmental monitoring and management is provided. The system comprises a centralized dashboard configured to receive, display, and analyze real-time data. It includes membrane bioreactors (MBRs) and Reverse Osmosis (RO) systems for water recycling. It also features energy management systems equipped with variable frequency drives, smart grids, and energy storage solutions.

A series of machine learning models are configured to forecast emissions based on historical data and current activities. All these subsystems are operatively coupled to the centralized dashboard, which is configured to enable preemptive actions to reduce water consumption, energy usage, and carbon emissions based on the received and analyzed data.

The integration of water and CO2 monitoring and reduction processes can provide a promising pathway toward more comprehensive and effective ESG management. Utilizing both current and emerging technologies, organizations can create synergies that align water and carbon strategies, enhancing efficiency, transparency, and sustainability. The continuous collaboration between technology providers, industry stakeholders, and regulators will be key to realizing the full potential of this integrated approach, driving progress toward a more sustainable and responsible future.

### Water Trading Platform

A water trading platform serves as a digital marketplace for the allocation and trading of water rights or water shares, aiming to achieve more efficient and equitable water use. It allows registered users, who may be individuals, companies, or government entities, to buy, sell, or lease water rights in a regulated and transparent manner. Interested parties start by registering on the platform by undergoing a verification process that might include identity validation and property assessments to determine water entitlements.

Once registered, sellers looking to lease or sell their water rights can list their available volumes on the platform, often with a set price or a price range. These offerings are usually subject to a verification process, where the platform validates the amount of water available for trade and ensures the sellers hold the necessary permits or water rights. Sellers can set various parameters on their listing, such as the minimum order quantity, duration of availability, and location, to better match with suitable buyers.

Buyers interested in acquiring additional water resources can browse these listings through a variety of filters like location, volume, and price. Upon choosing to make a purchase, the buyer initiates a transaction which often involves a smart contract. This digital contract details the terms of the trade, including volume, price, and other conditions, and automatically executes the transaction once all conditions are met. Payment methods can vary, but often include both traditional and digital payment options.

Blockchain technology might be implemented to provide a secure and transparent ledger for these transactions. The decentralized nature of blockchain ensures that all parties can validate transactions without a central authority, making the trade more transparent and secure. Unique identifiers could be assigned to each unit or batch of water rights traded, helping to ensure that each is only counted once and preventing double-selling.

The platform often includes advanced analytics and reporting capabilities, providing both macro and micro-level insights. Users can access real-time data on water availability, pricing trends, and transaction volumes. Such data is useful for resource planning and sustainability efforts, and it can also help policymakers and regulators understand market dynamics better. Regulatory reports can be easily generated and downloaded from the platform, simplifying the compliance process for users.

For added sophistication, the platform may leverage machine learning algorithms to predict water availability and price trends. This feature helps users make informed decisions based on predicted water scarcity or surpluses during specific seasons. This predictive analytics engine can take into account weather patterns, usage rates, and even policy changes to make these predictions.

In one embodiment, a water trading platform aims to optimize the allocation of water resources through a secure, transparent, and user-friendly digital marketplace. By incorporating advanced technologies like smart contracts and blockchain, as well as providing robust analytics, the platform addresses multiple challenges in water resource management. It offers a scalable solution for balancing supply and demand, facilitating regulatory compliance, and promoting sustainable water use.

The water trading platform not only serves as a digital marketplace but also as a comprehensive tool for water monitoring, usage, and conservation. For individual users, the platform can integrate with smart home systems to monitor real-time water usage, helping them to identify consumption patterns and potentially wasteful practices. They can then use this information to invest in water-saving technologies or make lifestyle adjustments, and perhaps even sell or lease their surplus water rights on the platform.

Governments can benefit by using the platform's data analytics capabilities to assess water consumption at different scales, from individual neighborhoods to entire cities or states. This data can inform public policy, enabling more precise targeting of water conservation measures. Government agencies can also use the platform to allocate water resources more efficiently during times of scarcity, prioritizing essential services or vulnerable communities.

Regulators can utilize the platform to enforce compliance with water rights and permits. By having a transparent, traceable record of all transactions and water usage, it becomes easier to identify and investigate cases of water rights infringement. The blockchain technology implemented in the platform ensures a tamper-proof and transparent record of all transactions. This significantly reduces the risk of fraud, making it easier for regulators to monitor compliance and enforce penalties where necessary.

Industries such as agriculture, manufacturing, and utilities can harness the platform to improve their water efficiency. By monitoring water usage data collected by the platform, they can identify areas for improvement and invest in water-saving technologies like efficient irrigation systems or wastewater treatment plants. Industries can also use predictive analytics features to anticipate water needs for different seasons, helping them to plan their water purchasing or selling activities more effectively.

The platform can also facilitate partnerships between these different stakeholders. For instance, an industry with excess water can enter into a long-term agreement to supply a nearby municipality, brokered and monitored through the platform. Similarly, conservation groups can purchase water rights through the platform to ensure the sustainability of critical natural habitats. Industries with slightly impaired water can find users of this water to avoid costly disposal and wasteful usage of potable drinking water.

In one embodiment, the water trading platform offers an array of features that go beyond simple transactions, providing a multi-dimensional approach to water management. Its robust monitoring and analytics capabilities, combined with the transparency and security offered by blockchain technology, make it a valuable tool for individual users, governments, regulators, and industries alike. By leveraging this platform, these stakeholders can make strides in water conservation, management, and sustainable usage.

### Combined Water and Carbon Trading Platform

The water trading platform not only serves as a digital marketplace but also as a comprehensive tool for water monitoring, usage, and conservation. For individual users, the platform can integrate with smart home systems to monitor real-time water usage, helping them to identify consumption patterns and potentially wasteful practices. They can then use this information to invest in water-saving technologies or make lifestyle adjustments, and perhaps even sell or lease their surplus water rights on the platform.

Governments can benefit by using the platform's data analytics capabilities to assess water consumption at different scales, from individual neighborhoods to entire cities or states. This data can inform public policy, enabling more precise targeting of water conservation measures. Government agencies can also use the platform to allocate water resources more efficiently during times of scarcity, prioritizing essential services or vulnerable communities.

Regulators can utilize the platform to enforce compliance with water rights and permits. By having a transparent, traceable record of all transactions and water usage, it becomes easier to identify and investigate cases of water rights infringement. The blockchain technology implemented in the platform ensures a tamper-proof and transparent record of all transactions. This significantly reduces the risk of fraud, making it easier for regulators to monitor compliance and enforce penalties where necessary.

Industries such as agriculture, manufacturing, and utilities can harness the platform to improve their water efficiency. By monitoring water usage data collected by the platform, they can identify areas for improvement and invest in water-saving technologies like efficient irrigation systems or wastewater treatment plants. Industries can also use the predictive analytics features to anticipate water needs for different seasons, helping them to plan their water purchasing or selling activities more effectively.

The platform can also facilitate partnerships between these different stakeholders. For instance, an industry with excess water can enter into a long-term agreement to supply a nearby municipality, brokered and monitored through the platform. Similarly, conservation groups can purchase water rights through the platform to ensure the sustainability of critical natural habitats.

In various embodiments, the water trading platform offers an array of features that go beyond simple transactions, providing a multi-dimensional approach to water management. Its robust monitoring and analytics capabilities, combined with the transparency and security offered by blockchain technology, make it a valuable tool for individual users, governments, regulators, and industries alike. By leveraging this platform, these stakeholders can make strides in water conservation, management, and sustainable usage.

In one embodiment, a combined water and carbon trading platform serves as a multifaceted solution for environmental sustainability by creating a unified marketplace for trading both water and carbon credits. Built upon a robust digital framework, the platform offers the ability to trade and monitor water and carbon allowances, all while ensuring complete transparency, traceability, and efficiency. U.S. Patent Publication No. 2023/0253789A1 discloses a carbon management system that utilizes AI that can be incorporated into embodiments disclosed herein. U.S. Patent Publication No. 2023/0253789A1 is hereby incorporated by reference in its entirety.

The platform integrates with smart meters for water, energy, and carbon emission sensors that feed real-time data into a centralized dashboard. This provides a multi-dimensional view of resource consumption, helping individual users, industries, governments, and regulators to make data-driven decisions. With advanced analytics and machine learning algorithms, the platform can forecast future consumption patterns, detect anomalies, and provide actionable insights for better resource management.

For individual users, the platform offers insights into their water and carbon footprints, with a feature that suggests optimal ways to reduce both. U.S. Patent Publication No. 2024-0059207 discloses a monitoring system suitable for single users or small businesses that can be incorporated into the embodiments disclosed herein. U.S. Patent Publication No. 2024-0059207 is hereby incorporated by reference in its entirety. Users can also sell or lease their surplus water rights or carbon credits in the marketplace, directly contributing to conservation efforts.

Governments can harness the platform's data analytics capabilities to monitor and manage resource consumption at various scales. From this data, targeted public policy measures can be enacted, such as introducing tiered pricing systems or resource allocation during shortages. The platform can also help governments in cap-and-trade programs, setting limits for carbon emissions and facilitating the trading of emission allowances among companies.

Regulators can use the platform's blockchain-based, tamper-proof records for compliance monitoring and enforcement. This enables a transparent and traceable record of all transactions in both water and carbon credits. Regulatory bodies can easily identify infringements and impose sanctions, thus ensuring a fair and trustworthy trading environment. U.S. Pat. No. 11,341,490B2 discloses a carbon footprint blockchain network that can be used in embodiments of this invention. U.S. Pat. No. 11,341,490B2 is hereby incorporated by reference in its entirety.

Industries benefit by utilizing the platform's predictive analytics to manage their water and carbon allowances proactively. With access to big data and machine learning models, they can forecast their future needs and purchase or sell allowances accordingly. Blockchain technology ensures that all transactions are immutable, creating a transparent and indisputable record that can be audited for compliance or sustainability reporting.

The platform also allows for seamless interaction between different types of stakeholders. For example, a corporation with excess water allowances can enter into a long-term agreement to offset the carbon emissions of a different industry. Similarly, conservation groups can acquire water rights to sustain natural habitats while also investing in carbon credits to offset their activities.

Advanced cybersecurity measures, such as end-to-end encryption, safeguard the data within the platform, providing users with the confidence to engage in transactions. Additionally, smart contracts automate many aspects of the trading process, reducing the need for intermediaries and making transactions quicker and more cost-effective.

In one embodiment, the Combined Water and Carbon Trading Platform is not just a marketplace but a comprehensive tool for achieving environmental sustainability. By integrating the complexities of both water and carbon trading, it provides a holistic solution that empowers individuals, governments, and industries to take collective action for a sustainable future.

In another embodiment, integrating energy consumption, usage, and conservation into the combined water and carbon trading platform further enhances its capabilities by creating a truly holistic resource management tool. By doing so, the platform can tackle three of the most pressing environmental challenges: water scarcity, carbon emissions, and energy efficiency, under one unified digital infrastructure.

In this advanced model, the platform can connect with a range of energy management systems, such as smart grids and renewable energy sources. These systems feed real-time, time-stamped energy usage data into the centralized dashboard, similar to the water and carbon metrics. By employing technologies like variable frequency drives and energy storage solutions, users gain the ability to closely monitor and manage their energy consumption patterns. Machine learning models can forecast energy needs based on historical data, seasonality, and current trends, enabling users to optimize energy usage and minimize waste.

For governments, the extended platform offers a more comprehensive data set for developing public policy initiatives in the energy sector. Cap-and-trade mechanisms could be extended to include energy credits, and governments can introduce incentives for the adoption of renewable energy sources. This makes it easier to develop and implement a unified policy aimed at reducing environmental impact across all three dimensions: water, carbon, and energy.

Regulatory bodies also benefit from the integrated approach. By having a complete, blockchain-secured record of transactions related to water, carbon, and energy trading, it becomes more straightforward to enforce compliance with various environmental standards and regulations.

Industries stand to gain by reducing their operational costs through better resource management. The ability to trade not just water and carbon credits, but also energy credits, offers more flexibility in managing their environmental footprint. For instance, an industry could choose to offset high energy consumption by purchasing water credits, thereby contributing to overall sustainability goals.

For individual users, the expanded platform can be an educational tool that fosters a deeper understanding of their total environmental impact. By tracking water, carbon, and energy metrics side by side, users can make more informed decisions about how to allocate their resources, whether that means installing solar panels, recycling greywater, or reducing energy consumption through smart home technologies.

The inclusion of energy metrics into the Combined Water and Carbon Trading Platform offers a synergistic approach to resource management. It brings additional layers of data analytics, policy options, and user engagement opportunities, providing a more comprehensive and effective solution for achieving global sustainability goals.

### Integrating Food Energy and Water Monitoring

In today's interconnected world, the efficient use of resources such as food, energy, and water can be important. In one embodiment, the proposed system is a centralized dashboard that aggregates real-time data from various sources. This dashboard seamlessly integrates information about water availability, energy consumption, and food production metrics, providing a one-stop-shop for users to monitor their usage, trade credits, and implement conservation measures.

Equipped with advanced sensors for monitoring water flow, energy usage, and even soil moisture levels, the system delivers granular data that can be harnessed for better decision-making. These sensors can be installed in agricultural fields, energy grids, and water supply chains, continuously sending data back to the centralized dashboard for analysis. Alongside the data aggregation, a trading interface is embedded into the platform, allowing users to buy and sell credits for each of the three resources—water, energy, and food. By enabling real-time trading, the platform encourages efficient usage and redistributes excess capacity to where it is most needed.

In one embodiment, a distinguishing feature of the platform is the incorporation of data analytics and machine learning algorithms. These technologies not only display current usage patterns but also predict future needs and potential shortages across all three sectors—water, energy, and food. Cutting-edge artificial intelligence algorithms operate in the background to identify optimal patterns for resource utilization. For example, the AI could recommend a crop rotation plan that maximizes yield while minimizing water and energy consumption or suggest adjustments to energy consumption during peak hours to reduce costs and carbon footprint.

The adoption of blockchain technology adds another layer of integrity to the system. All transactions are transparent, secure, and immutable, providing a reliable and tamper-proof record of resource allocation that is especially useful for regulators and policymakers. The platform's multi-dimensional approach to resource management acknowledges the interconnectedness of water, energy, and food. For instance, the water required for food production is accounted for in the water credits, leading to a more holistic view of resource usage.

In one embodiment, the platform also encourages the adoption of energy-efficient practices by making it financially attractive to trade energy credits, thus stimulating investment in renewable energy sources. This contributes to a more sustainable future and has the added benefit of reducing both food and water insecurities. By enabling better resource allocation and promoting efficient practices, the platform can help ensure a more equitable distribution of food and water, particularly in regions that are most vulnerable to shortages. In summary, this trading system aims to revolutionize the way we think about and manage these vital resources. Its seamless integration of real-time monitoring, advanced analytics, and secure trading mechanisms provides a comprehensive solution for improving resource utilization and sustainability.

### Incorporating AI and ML Into the Platform

The incorporation of artificial intelligence (AI) and machine learning (ML) into the trading platform can significantly enhance its capabilities, providing a more dynamic, predictive, and efficient experience for all stakeholders. AI algorithms, trained on vast datasets collected by the platform, can recognize patterns and trends in resource consumption and distribution across water, energy, and food sectors. They can analyze multiple variables such as weather conditions, seasonal changes, and market demand to predict shortages or surpluses in resources. By doing so, the platform can offer proactive solutions, such as adjusting prices for trading credits or issuing alerts for possible resource scarcity in specific regions.

Machine learning algorithms can be particularly beneficial for real-time decision-making. They can continually adapt and learn from the data, providing more accurate and timely recommendations as they get more information. For example, a machine learning algorithm could predict when a farmer would need to irrigate crops and notify them to purchase water credits in advance, ensuring that they pay the most economical rate. Similarly, the algorithm can forecast periods of low energy demand, allowing users to trade or bank their energy credits at the most opportune times.

Another aspect where AI and ML can prove invaluable is in the realm of fraud detection and security. Traditional platforms might require extensive manual checks for anomalies in trading activities, but AI algorithms can automatically flag suspicious transactions in real-time, making the platform more secure and trustworthy. These algorithms can also adapt to new types of fraudulent activities, making the system more resilient to threats over time.

The AI can also assist in regulatory compliance by providing comprehensive and transparent records of all transactions. AI can generate reports that meet specific government or industry standards, thereby simplifying what could otherwise be a complex and time-consuming process. This ensures that all transactions are conducted within the legal framework and can be audited efficiently, which is crucial for gaining the trust of regulators and users alike.

Personalization is another feature that AI can offer. By analyzing individual user behavior and preferences, the AI can provide a customized trading experience. For instance, if a user frequently trades water credits but has not engaged in energy credit trading, the AI could highlight potential benefits and opportunities in the energy sector, encouraging a more holistic approach to resource management.

The incorporation of AI and ML technologies can thus elevate the trading platform from a mere transactional interface to an intelligent, adaptive, and secure ecosystem. This, in turn, creates an environment where resources are allocated more efficiently, and sustainable practices are not just encouraged but systematically integrated into the trading process.

### Integration of a Decentralized Autonomous Organization (DAO)

The integration of a Decentralized Autonomous Organization (DAO) can further revolutionize the trading platform by enhancing transparency, accountability, and community governance. A DAO operates on blockchain technology, providing a system where rules are embedded into code and automatically executed, leaving little room for fraud or manipulation. This not only secures the integrity of transactions but also makes the platform truly decentralized, removing the need for a central authority to oversee the trades.

The key benefit of integrating a DAO into the platform is that it gives stakeholders, such as users, governments, and industry representatives, a voice in the platform's development and rule-setting. Token holders can propose changes, and those proposals are subject to community voting. This ensures that decisions regarding rule changes, fee structures, or any significant platform modifications are made democratically, giving all users a stake in the platform's future. Such an approach can inspire more trust and user engagement, as people tend to be more invested in platforms where they have a say in governance.

In a trading platform focused on critical resources like water, energy, and food, trust is paramount. The immutable record-keeping capabilities of a DAO ensure that all transactions are transparent and verifiable by any participant in the network. This transparency can help the platform meet regulatory requirements more easily and can reassure users that their transactions are being conducted fairly.

The use of smart contracts within a DAO can also automate many aspects of the trading process. These self-executing contracts with the terms directly written into code can facilitate, verify, or enforce credible transactions autonomously. For instance, smart contracts can be programmed to automatically release water credits once a payment has been verified, or to distribute dividends among stakeholders based on pre-set rules, without the need for manual intervention.

Additionally, a DAO could implement decentralized finance (DeFi) mechanisms to provide liquidity and facilitate borrowing and lending within the trading ecosystem. This could enable more dynamic trading strategies and financial structures, such as futures contracts for water credits, or the pooling of resources for collective action like environmental cleanup or infrastructure development.

Moreover, the DAO could be programmed to dedicate a percentage of transaction fees or other revenue toward social and environmental goals. This aligns the platform with broader sustainability initiatives and can help in reducing food and water insecurities by directing funds to projects that aim to address these issues.

By making the platform user-centric and leveraging blockchain's strengths in transparency and security, a DAO transforms the trading platform into a more equitable, efficient, and robust ecosystem. The result is a self-sustaining system that is more responsive to the needs of its community and more effective in fulfilling its mission of optimizing resource management.

### Water Footprint Schematics

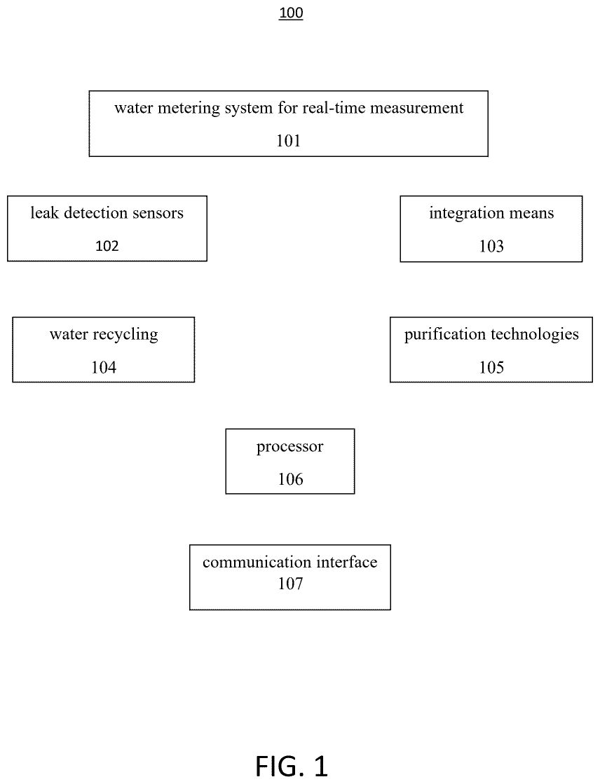

FIG. 1 is a schematic embodiment of how a water footprint system 100 works. In this embodiment, a water metering system for real time measurements is deployed 101. Leak detector sensors 102 are deployed. A system integration means 103 such as, PLCs, server, servers, cloud are utilized. Water recycling devices and methods 104 and other water purification technologies 105 are incorporated into the water footprint system 100. A processor 106, such as a PLC, laptop, computer, server or cloud is used to integrate sensors, equipment and systems. A communication interface 107 transmits the data, analysis, actions, and recommendations to the user or other systems integrated into the water footprint system

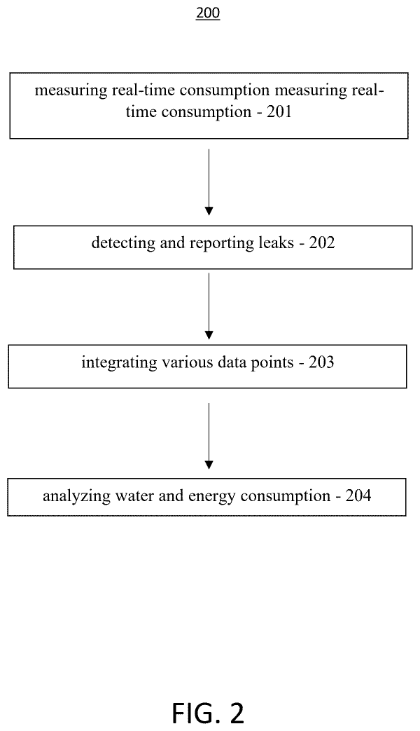

FIG. 2 is a flow chart embodiment of how a water footprint method 200 works. First, water properties are measured in real time or near real time 201. Second, leaks are detected and reported 202. Third, various data points are integrated 203 into the water footprint system to give the user or decision maker the data necessary to operate the system. Finally, water, carbon, and/or energy consumption are analyzed 204. Additional embodiments can include communicating the analysis and using AI, ML, and DAO capabilities to make recommendations and decisions.

### Hypothetical Example of the Platform

Below is a hypothetical example. The hypothetical example is written to showcase many of the features of the invention but is not meant to limit the invention.

In this example, a user logs into a cutting-edge trading platform that offers integrated solutions for trading water, energy, and carbon credits. Upon initial login, the user finds a centralized dashboard that provides real-time data on water, energy, and carbon markets. The seamless registration process incorporates blockchain technology, ensuring that all transactions are transparent and immutable.

The user decides to list surplus clean water and renewable energy on the platform. They utilize smart contracts to dictate the terms of the trade. These smart contracts are self-executing, thanks to the platform's use of decentralized autonomous organization (DAO) mechanisms. This ensures that the contracts are not only secure but are also governed by the community, adding an additional layer of trust and transparency.

Participating in the platform's governance, the user takes part in community voting. Decisions about the platform's operation and fee structures are made collectively, allowing everyone to have a voice. This feature reinforces the decentralized nature of the platform.

While looking for trading opportunities, the user discovers the liquidity pool feature. This feature allows for quick, low-fee transactions, and the gains are distributed among the participants automatically. This efficiency improves overall water and energy usage by facilitating easier and more economical trades.

To offset their carbon footprint, the user buys carbon, energy and/or water credits through the platform. Carbon, energy, and/or water sensors integrated within the platform track and to verify different emissions, giving the user a multi-dimensional view of their carbon, energy, and/or water footprint and overall resource consumption. This feature is made possible by machine learning algorithms that analyze data to provide actionable insights.

As the user continues to use the platform, machine learning algorithms analyze their trading patterns and consumption behaviors. The platform offers predictive analytics, which enables the user to identify potential surpluses and shortages in advance. This helps the user make proactive decisions, leading to optimized energy and water usage, as well as more effective carbon offsetting.

The platform also includes decentralized finance (DeFi) modules, which allow the user to lend surplus resources at a premium. This feature not only generates additional income for the user but also encourages efficient utilization of resources across the community.

Moreover, the platform uses AI algorithms to identify potential synergies and partnerships that could help reduce food and water insecurities. It suggests that by collaborating with certain projects or communities, the user could amplify their impact on resource conservation and availability.

Throughout the user's experience, all data and transactions are secured with end-to-end encryption and other cybersecurity measures. This protects the user while ensuring transparent and verified transactions.

By leveraging the platform's features, the user maximizes the efficiency of their resource usage and trading. They contribute to a community that prioritizes transparency, sustainability, and the effective use of natural resources, finding immense value in how the platform combines complex systems into a unified and user-friendly tool.

What is claimed is:

1. A water monitoring and management device comprising:
a. a water metering system for real-time measurement of water consumption;
b. leak detection sensors for reporting detection of leaks;
c. integration means for various water recycling and purification technologies;
d. a processor to analyze water usage data;
e. a communication interface; and
f. wherein the device automatically closes a water valve upon the detection of a leak by the leak detection sensors using data analytics to prevent water loss.

2. The device of claim 1, wherein the leak detection sensors are equipped with ultrasonic technology for enhanced accuracy and combine ultrasonic data with pressure sensor data to detect a leak and report a leak.

3. The device of claim 1, further comprising a cloud computing platform for efficient data storage, sharing, and collaboration, wherein the cloud computing platform integrates energy consumption records and the water metering system records time-stamped consumption data.

4. The device of claim 3, wherein the processor utilizes machine learning algorithms to predict water consumption patterns and includes edge-computing resources that perform on-device feature extraction to reduce latency and provide data integration from multiple sources to create a multi-dimensional view of resource consumption.

5. The device of claim 4, further comprising a user interface for displaying real-time consumption data and trend analysis by integrating a plurality of smart water sensors into a centralized dashboard, wherein the centralized dashboard receives, displays, and analyzes real-time data.

6. The device of claim 5, wherein the integration means includes a connection to water purification technologies, wherein the water purification technologies are chosen from the group consisting of membrane bioreactors (MBRs), thermal distillation systems, filtration systems, water recycling system and reverse osmosis (RO) systems, and combinations therein.

7. The device of claim 6, wherein the communication interface engages customers with personalized water consumption information and recommendations and trade water credits based on individualized consumption forecasts and leak-avoidance savings, wherein the cloud computing platform records water-usage data and leak data on an immutable blockchain for secure and transparent record keeping.

8. A system for comprehensive combined CO₂ and water monitoring comprising:
a. water footprint monitoring services;
b. CO₂ monitoring subsystems;
c. footprint reduction processes for both water and carbon;
d. an integrated dashboard for real-time insights; and
e. wherein the water footprint monitoring services include the use of smart meters and IoT sensors, and wherein the smart meters are configured to trigger automated valve-closure actions upon anomaly detection by the IoT sensors using data analytics to prevent water loss

9. The system of claim 8, wherein the system maintains real-time blockchain-backed ledgers for water and carbon footprints to ensure auditable tracking.

10. The system of claim 9, further comprising a centralized platform leveraging cloud computing, big data analytics, artificial intelligence, and combinations thereof, and wherein the platform implements big data analytics to process concurrent water, energy, and carbon streams.

11. The system of claim 10, wherein the footprint reduction processes include water treatment connected to the system, wherein the water treatment is selected from the group consisting of wastewater recycling using membrane bioreactors, water purification through reverse osmosis, water recycling, energy recycling for water treatment, and renewable energy sourcing for water treatment, and combinations thereof, and wherein footprint reduction processes includes carbon footprint and water usage.

12. The system of claim 11, further comprising automation and machine learning components for predictive modeling and automated controls to reduce energy consumption in the water treatment.

13. The system of claim 12, wherein the integrated dashboard pulls data from both water and carbon monitoring devices and further integrates third-party verification services via APIs to validate water-usage data across a value chain.

14. The system of claim 13, wherein the system considers energy efficiency, renewable energy integration, and lifecycle assessments in water management and energy management systems using data from the CO₂ monitoring subsystems.

15. A method for monitoring, managing, and reducing water usage comprising:
a. measuring real-time consumption using sensors for monitoring water flow;
b. detecting and reporting leaks using data from the sensors for monitoring water flow;
c. integrating various data points for efficient control over water usage; and
d. analyzing water and energy consumption, wherein the method further comprises automatically closing a water valve upon detection of a leak to reduce water waste using data analytics.

16. The method of claim 15, further comprising utilizing IoT devices for real-time monitoring and control to determine water usage and triggering smart contracts that authorize remediation actions and allocate water credits based upon data.

17. The method of claim 16, wherein analyzing water consumption includes performing life cycle assessment of water usage throughout energy production and applying a three-level water-footprint framework including water consumption, energy consumption, and carbon footprint.

18. The method of claim 17, further comprising collaborating with energy providers to gain insights into water intensity to offset water usage, wherein collaboration includes provider APIs to obtain water-intensity metrics normalized by generation stack.

19. The method of claim 18, wherein detecting and reporting leaks includes using advanced algorithms to minimize waste, and further comprises anomaly detection with machine learning using data from the sensors for monitoring water flow and pressure sensors.

20. The method of claim 19, further comprising engaging with information about water consumption patterns including recommendations to trade water or energy using artificial intelligence to improve resource conservation.
